(19) United States
(12) Patent Application Publication
(10) Pub. No.: US 2014/0317951 A1
(43) Pub. Date: Oct. 30, 2014

(54) DEVICE FOR FILTRATION, DRYING AND STORAGE

(71) Applicant: Bayer Intellectual Property GmbH, Monheim (DE)

(72) Inventors: Joerg Kauling, Bergisch Gladbach (DE); Andre Pütz, Dusseldorf (DE); Dirk Havekost, Koln (DE); Jörg Peters, Erkrath (DE)

(73) Assignee: BAYER INTELLECTUAL PROPERTY GMBH, Monheim (DE)

(21) Appl. No.: 14/359,065

(22) PCT Filed: Nov. 14, 2012
(86) PCT No.: PCT/EP2012/072581

§ 371 Date: May 16, 2014

(30) Foreign Application Priority Data
Nov. 16, 2011 (EP) 11189343.4

(51) Int. Cl. F26B 17/00; B01D 9/00; B01D 29/00

(52) U.S. Cl. CPC F26B 17/00; B01D 29/00; B01D 9/00
USPC 34/381; 210/450; 210/259; 210/253

(57) ABSTRACT

The invention relates to a device for filtration, drying and storage of solids from a suspension (FDS unit) and a method carried out in this system for the downstream processing of a solids suspension, in particular of crystallizable therapeutic proteins or active ingredients. The FDS unit, designed for use as a disposable system, is a device with which active ingredient crystals can be gently and safely filtered, dried, stored and reconstituted in a closed process procedure, i.e. without intermediate opening or transfer.

The invention relates to a device for filtration, drying and storage of solids from a suspension (FDS unit) and a method carried out in this system for workup and drying of a solids suspension, in particular of crystallizable therapeutic proteins or active ingredients. The FDS unit, designed for use as a disposable system, is a device with which active ingredient crystals can be gently and safely filtered, dried, stored and reconstituted in a closed process procedure, i.e. without intermediate opening or transfer.

The production of pharmaceutically active peptides and proteins and also therapeutic antibodies proceeds in what is termed “Upstream Processing” (USP) by fermentation. Then, the proteins are purified in what is termed “Downstream Processing” (DSP) and converted as per formulation into a dosage form suitable for medical application.

For the DSP, currently separation methods based on chromatography are generally used. The requirements with respect to purity and freedom from contamination of the purification methods that are made up of a plurality of separation steps have constantly been increasing according to the experience of recent years. This relates especially to the production of pharmaceutical active ingredients such as, for instance, therapeutic peptides and proteins, in order to exclude unintended biological side effects due to the numerous by-products formed during the fermentation. For the most rigorous avoidance of contamination, sometimes highly complex and expensive DSP steps are required.

This critically affects the economic efficiency of the overall process, especially since in recent years, owing to the increase in efficiency in USP, a considerable cost shift at the expense of DSP has taken place. Experts forecast a continuation of this trend and also a further increasing deficit in capacity which today may already be considered as the critical bottleneck of many bioprocesses (http://biopharminternational.findpharma.com/biopharm/Trends/Downstream-Processing/ArticleStandard/Article/detail/627965).

In order to be able to counter the strong pressure on costs, in the biopharmaceutical industry, new highly efficient, inexpensive and resource-sparing purification and storage methods are required for therapeutic proteins and peptides. These methods have a critical effect on whether biotechnological methods can survive in the long term in competition (Presse-Information; ACHEMA 2009; 29. Internationaler Ausstellungskongress für Chemische Technik, Umweltschutz and Biotechnologie; Frankfurt am Main, 11.-15. Mai 2009; Trendbericht Nr. 20: Selektive Trenntechniken [Press information; ACHEMA 2009; 29th International Exposition for Chemical Technology, Environmental Protection and Biotechnology; Frankfurt am Main, 11-15 May 2009; Trend Report No. 20: Selective Separation Techniques]).

In comparison with the chromatographic separation techniques now predominantly used for producing therapeutic proteins, highly selective protein crystallization can represent an economic alternative. The method which was originally employed for elucidation of three-dimensional molecular structure by X-ray crystallography, as technical protein crystallization, is increasingly gaining access to modern purification methods. In this purification method, the solubility of the proteins is gradually decreased by careful addition of precipitants until first crystals are exhibited after a few minutes to hours. The advantages of the technology compared with the alternative methods substantially consist in the combination of the following features:
high degrees of purity which are achieved in a single process step,
high specificity with which, inter alia, even protein isoforms and/or glycosylated variants may be separated,
low costs,
high storage stability of the crystals,
reduced product losses during storage,
high concentration of the crystals with relatively small apparatus volumes for storage,
cost-efficient use of classical solid-liquid separation methods after crystallization,
the option of a slow-release formulation for equalizing the bioavailability of the active ingredients

Navarro et al. (Separation and Purification Technology 2009, 68: 129-137) summarize the advantages of protein crystallization as follows:

| Conditions | Crystallization | Chromatography |
|---|---|---|
| Temperature | low (0-50° C.) | low (0-50° C.) |
| Time | relatively long | relatively short |
| Instrument costs | $2/month | $20/day without columns |
| Laboratory costs | $30/hour | $30/hour |
| Separation | one-step | multistep |
| Solvent quality | relatively low | relatively high |

Owing to the chemical and thermal instability of proteins, the methods to be used in an industrial production are restricted especially in downstream processing. During storage of proteins in solution, minor physicochemical changes in the microenvironment of the proteins (pH shifts, changing of ionic strength or the temperature) can lead to a reversible or mostly to an irreversible change in tertiary structure which is accompanied with a loss of activity. In addition, there is the fact that proteins can be deactivated by, inter alia, aggregation, hydrolysis, deamidation, isomerization, deglycosylation and oxidation or reduction.

The stability problems can be minimized by storing protein solutions at the lowest possible temperatures. By this means, the rate of possible chemical modification reactions is reduced. In addition, the surrounding environment of the proteins can be optimized in such a manner that the effects of denaturation are minimized. The proteins can likewise be stabilized by drying, since by removal of the water, the reactions are retarded, in such a manner that they no longer occur, or occur considerably retarded, during storage. If deamidation and hydrolysis of the proteins in solutions are the main problems, these processes play a minor role in the dried state (McNally, E. J.; Pharm. Sci., 2000; 99). In addition, it has been observed that oxidation reactions decrease with decreasing residual moisture content (Franks, F., Bio/Technology. 1994, 12, 253-256; Christensen, H.; Pain, R. H. Molten globule intermediates and protein folding. Eur. Biophys. J. 1991, 19, 221-229). The substantial advantage of drying proteins is the increased thermal stability thereof, which in turn leads to improved storage stability.

The current standard method in the pharmaceutical industry is freeze drying (lyophilization) (Cleland, J. L et al., Critical reviews in therapeutic drug carrier systems. 1993, 10,307-377; Wang, W., Int. J. Pharm. 2000, 203, 1-60). This method which may be operated continuously or discontinuously dries uniformly at low temperatures. Reconstitution of the proteins generally proceeds rapidly and without problems. The increased time (up to a week) and energy requirements, however, lead to a very cost-intensive method which in addition can also have a denaturing effect on proteins. Lyophilization is only usable as a final process step for short-and long-term storage. Purification as in technical protein crystallization does not take place.

Therefore, protein crystallization with the combined possibility of highly specific product purification with simultaneous improvement in storage stability is a particularly cost-efficient method.

In the context of DSP of dried crystals, transfer of active products gives rise to considerable risks of contamination for the environment (exposure of personnel) and product (crosscontamination). In particular, handling dry pulverulent substances involves a very high hazard potential. In order to exclude crosscontamination between product batches and particularly between different products, the equipment used for solid-liquid treatment must, before repeated use, be subjected to an intensive cleaning procedure with subsequent cleaning validation, which gives rise to high expenditure in terms of staff and time. In addition, open handling demands expensive cleanroom surroundings and also complex safety measures (protection against exposure, protection against dust explosions etc.).

A processing of pharmaceutically active protein crystals (or crystals of other pharmaceutically active substances) including separation, drying, transport, storage and reconstitution, should therefore proceed in such a manner that neither are staff put at hazard by escape of substances, nor is there a risk of contamination for the product. Error-free application of the listed process steps, and also the reduction of expenditure in terms of staff and time, are of decisive importance for safe and economic application of crystallization in the DSP. To date, for this problem, no adequate technical solution has yet been described with respect to the special requirements for handling of biotechnological active ingredients.

In the current literature, only few methods are described which are concerned with the technical workup of protein crystals and storage thereof.

For instance, patent WO 00/44767 A2 describes the use of a centrifugal drier for isolating (filtration), washing and drying and further processing of insulin crystals. Particular attention is paid here to introducing a drying medium which comprises a mixture of water and a nonaqueous solvent that is miscible with water in any ratio and has a lower vapour pressure than water. In addition, for drying, a nitrogen stream moistened with water is used. The amount of water is given by the optimum residual moisture determined for the protein (insulin and insulin derivatives). Disadvantages in this procedure are the great complexity of apparatus of the centrifugal drier and the associated effort for cleaning and cleaning validation.

The object of the present invention was therefore to provide a device for filtration, washing, drying, transport, storage and, optionally for resuspension/resolubilizing of crystalline active ingredient products which can be handled simply, safely and in a product-sparing manner, wherein a risk of contamination is minimized or excluded.

The abovementioned object has been achieved by providing a device usable as a disposable system which permits in a single vessel-i.e. without intermediate opening-the sequential steps of filtration, washing, drying, sample removal, transport, storage and resuspension/resolubilization-which device is termed hereinafter “FDS unit”. Using the FDS unit crystalline proteins or peptides may be provided in a product-sparing manner without the risk of product contamination for the following formulation steps. Product losses or the endangering of staff by unintended product release, e.g. dangerous dust emissions, can be reduced to a minimum by the closed process procedure.

The present invention therefore firstly relates to a filter unit (FDS unit) for filtration of solid particles from a suspension, comprising:
a filter housing (10) comprising a filter chamber (13), a liquid distributor (50) at the end of at least one inlet (15) to the filter chamber (13) and a base (12) and a filter medium (11), wherein the filter chamber (13) and the base (12) are connected in the region of the filter medium (11) by a connection so as to seal against the surroundings and against the filter medium (11),
at least one outlet (14) on the base (12) of the filter housing (10).

The material of the FDS unit is selected in such a manner that the cleaning and sterilization methods customary in the pharmaceutical industry, such as autoclaving or gamma irradiation, can be used.

As filter media (11), filter plates or filter cloths that are typically made of fibres or sintered materials and are suitable for pharmaceutical purposes are used which consist of suitable materials known to those skilled in the art such as plastics, glass, metals or ceramic materials, have a pore size which is optimized to the filtration process or the product properties with respect to product loss, throughput and/or pressure drop. Particular preference for use as the FDS unit as a disposable system is given to the use of inexpensive materials, for example, sintered plates or sintered fabric made of stainless steel or plastics materials such as, for example, polyethylene, polyester, polyphenylene sulphide, polytetrafluoroethylene. Pore sizes from 0.2 to 50 μm are used, depending on the particle size or particle size distribution of the crystalline active ingredient achievable in the crystallization process. For the optimal filtration process, for each product, a maximum possible pore size is individually selected with which high throughputs or filter surface loadings are achievable without blockage of the filter plate due to penetrating product or causing flushing of the suspension.

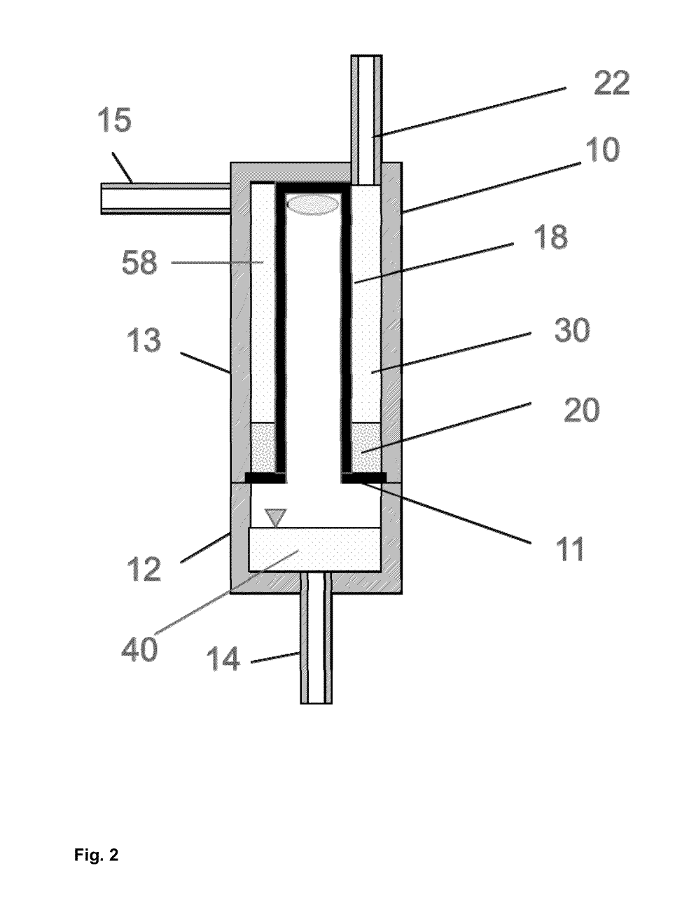

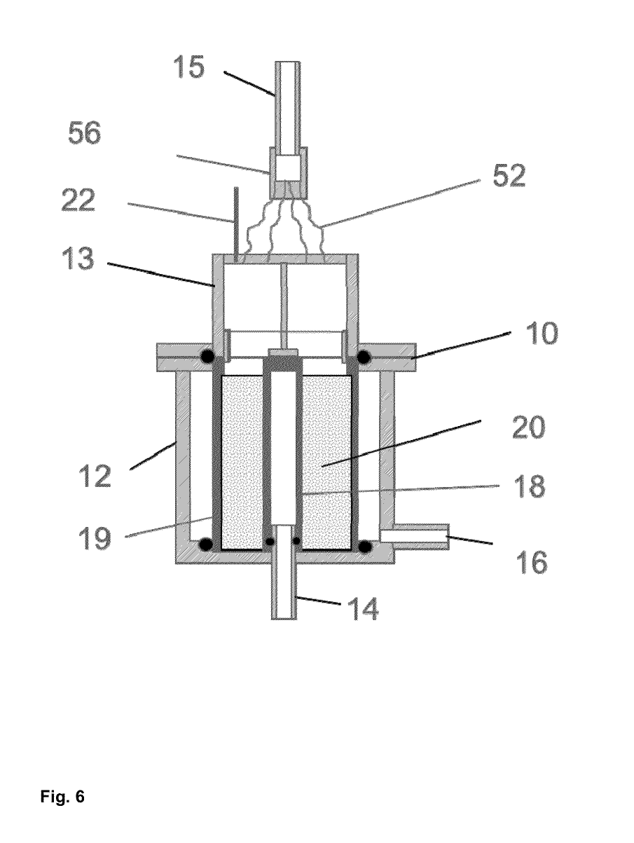

Preferably, the filter medium (11) is clamped into the filter housing (10) horizontally as a filter plate (17). To increase the specific filter surface area, it can be expedient to construct the filter element as a continuous, preferably cylindrical, tube or as a filter candle (18) (FIGS. 2 and 6), which can be surrounded by a concentric outer filter tube (19) (FIG. 6). In this case, the filtration takes place in an annular space formed by the filter tube (19) and the filter candle (18), with the gap width (58).

The filter housing (10) is customarily made of plastics that are permitted for medicament production. For the production of the filter housing, standard methods for shaping plastic (injection moulding, extrusion, etc.) are used. Preferably, the filter housings are produced from thermoplastics that are known to those skilled in the art such as, for example, polyethylene, polypropylene, PMMA, POM, polycarbonate (in particular Makrolon).

The product-contacting walls of the filter chamber (13) and, under some circumstances, also of the base (12), are, in a preferred embodiment, also made of plastics films and thereby the filter housing is constructed entirely or in part as a plastics pouch. In this case, the overpressure required for filtration is transmitted at least within the filter chamber (13) via the pouch walls to a pressure-stable holding device. This solution is preferably used for relatively large scales from approximately 5-50 I, from which the costs of the FDS unit otherwise could make a single-use application difficult. In order, as a readily detachable connection between filter chamber (13) and base (12), to be able to use typical clamping connections with a closable clamp (e.g. Triclamp), it can be expedient to provide filter chamber (13) and base (12) with corresponding connection flanges. Alternatively, the filter housings can be bolted to one another (e.g. using a threaded or bayonet connection). In a further preferred embodiment, filter chamber (13) and base (12) are non-detachably connected to one another by means of a welded, glued or compression joint.

A resuspension/resolubilization of the protein crystals within the FDS unit is desirable for the closed processing of the product in sealable FDS units, but is absolutely necessary for product withdrawal in the case of non-detachable connections between filter chamber (13) and base (12). The energy input required for an accelerated resuspension/resolubilization is in this case preferably introduced into the filter chamber (13) non-invasively, i.e. without intervention into the closed system, e.g. via an orbital or rotary-oscillating shaking. In order to be able to use the mixed method of rotary oscillation, it can be expedient to provide the filter housing (10) with flow-breaking elements (e.g. flow disrupters or a polygonal cross section), at least in the region of the filter chamber (13).

For carrying out the filtration, a suspension (30) of protein crystals is fed into the filter chamber (13). The filter chamber (13) in this case is vented via a sealable venting tube (22). The usual size of the FDS unit for the small scale is 5 ml and 500 ml. However, on the large scale, FDS units having a total volume of up to 50 I or above can also be produced. The degree of slenderness (ratio of height to diameter H/D) of the filter chamber (13) depends on the type and efficiency of the liquid distribution at the top of the filter housing (10) and also on the optimally achievable height of the filter cake (20). The degree of slenderness is customarily selected in such a manner that a filter cake height of 1 to 20 cm, preferably between 2 and 8 cm, particularly preferably between 3 and 5 cm, can be achieved in the device, wherein the specific properties of the protein crystals that are to be filtered, in particular size, stability, and compressibility of the crystals are taken into account.

Because of possible pressure drop problems (the pressure drop depends, in addition to the size distribution, stability and compressibility of the crystals and the viscosity of the solution, considerably on the cake height), an approximately constant cake height is advantageous on scale up. Owing to the use of horizontal filter plates (17), this means that the H/D ratio of the filter chamber continuously decreases with scale up. In order nevertheless to achieve a uniform cake height, at relatively large scales, optionally means for effective liquid distribution are necessary.

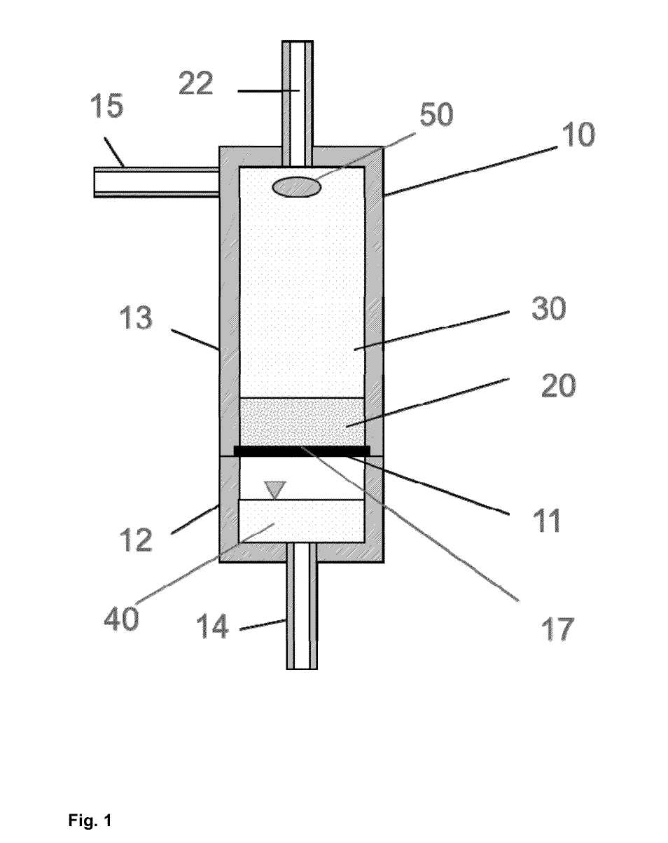

Usually, the suspension (30) of protein crystals is fed into the filter chamber (13) via the liquid distributor (50) having at least one inlet (15) (FIGS. 1, 2, 4, 5, 6 and 7). Preferably, the suspension (20) is introduced into the FDS unit in such a manner that the filter cake (20) builds up evenly. The even buildup of the filter cake (20) is of essential importance for the functioning of the FDS unit, because it determines the duration and intensity of drying and thereby the extent of unwanted product contamination and side reactions causing losses of activity.

In the case of small sizes of 5 ml and 500 ml and/or high degrees of slenderness of H/D ≧1 of the FDS unit, the suspension (30) is fed via a liquid distributor (50) preferably consisting of a single inlet (15) having a tangential or central-axial feed orientation (FIGS. 1 and 2).

However, in the case of large filter chambers (13) of up to 50 I and/or small degrees of slenderness H/D <<1, a considerably better distribution of the suspension over the cross section of the filter chamber (13) is advantageous. The liquid distributor (50) for this purpose is preferably equipped with a distributor plate (54).

Liquid distributors having a distributor plate are frequently used in chromatography but are mostly unsuitable for distributing suspension owing to the low channel height, because of sharp bends, dead spaces and the lack of falling orientation of the lines (settling of solids). WO2010/138061 A1 describes a tree-shaped liquid distributor having a distributor plate in which the exit openings are arranged in a grid shape. The complicated tree-shaped line structure is produced by “free form fabrication” and is particularly simple to clean. The distributor described would be thoroughly suitable for distributing a suspension, but is complicated in production and expensive for the single use application sought-after here.

The object was therefore to provide a liquid distributor which is suitable for uniform distribution of a suspension, i.e. has no dead spaces, and permits continuous regular falling of the suspension via the distributor plate, wherein this distributor should be simply and expediently constructed.

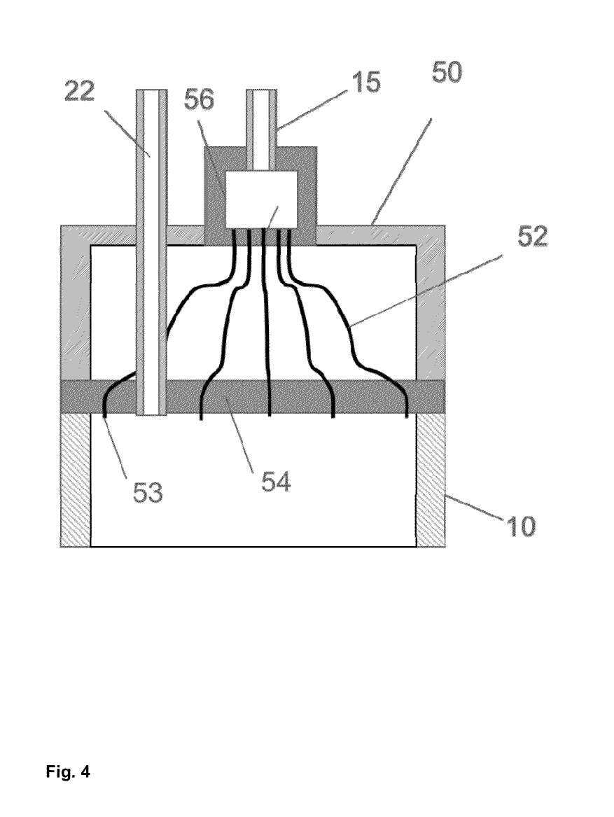

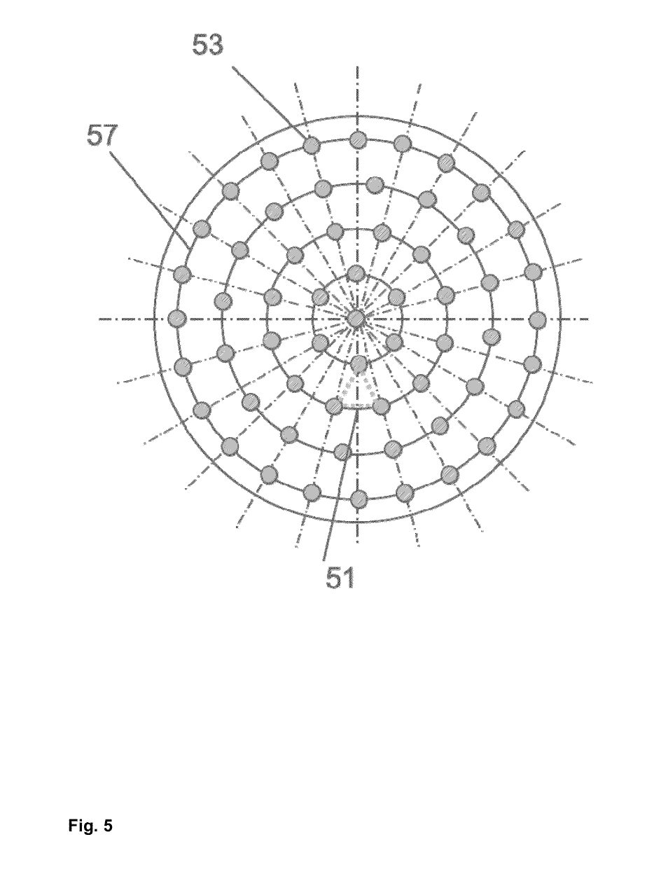

The liquid distributor (50) according to the invention suitable for single-use applications has a predistributor (56) connected to a distributor plate (54) by means of flexible tubular lines (52) of equal length and equal diameter and thereby approximately the same pressure drops (FIG. 4). The flexible tubular lines (52), with expansion and a gradient as continuous as possible, open out (avoidance of solids deposits) into vertical exit openings (53) of a distributor plate (54). Expedient angles of attack of the outer tubular fibres are, depending on the diameter of the FDS unit, between 5° and 75° , particular preference is given to angles of attack of 20-60°. The distribution of the exit openings (53) on the distributor plate (54) is usually such that (FIG. 5) the openings, firstly, by analogy with a 60° division, have an approximately constant spacing from one another and, secondly, nevertheless, are positioned on a circle line (57), in order to achieve a uniform distribution, even close to the wall. The distance from the wall of the exit openings (53) corresponds in this case preferably to half the distance of the circle lines (57) from one another. The number of bore holes per unit circumference is kept constant in this design suitable for vertically arranged filter plates (17) and increases by 6 exit openings (53) in each case in the jump to the next greater circle line (57). The number of exit openings per surface required for adequate solids distribution depends on numerous factors such as, e.g., the particle density and particle size distribution, and on the falling velocity of the particles, the filtration rate, the height of the filter cake (20) and the degree of slenderness of the filter chamber (13). A filter chamber (13) charged via the distributor according to the invention and having the diameter of 190 mm, in a model experiment using 10 g/I PANX particles, delivered a median absolute height difference of approximately 2%-3%, based on the cake height approximately 40 mm and thereby at an H/D ratio of H/D=0.5, already a sufficiently good particle distribution. The distributor required therefor has 7 exit openings with a bore hole spacing of approximately 63 mm.

In a particular embodiment of the distributor according to the invention, each exit opening is connected to a predistributor (56) with the aid of an unbranched flexible tubular line (52). Usually, as flexible tubular line, silicone flexible tubes are used. Usually, the flexible tubular lines are pushed on, cast, welded or adhesively bundled in the predistributor (FIG. 4).

The predistributor is usually supplied with the suspension (30) via an axially or tangentially arranged feed (15).

In a further enlargement of the process scale, or in the case of products that are difficult to filter, it may be advantageous not to build up the filter cake on a surface, but in the annular space between a filter candle (18) and a filter tube (19) (FIG. 6). This produces the great advantage that the pressure drop can be set independently at the height of the filter cake. As a result, independently of the scale, a slender geometry may be effected which, inter alia, generates considerable advantages in the space requirements or the pressure load-bearing capacity of the apparatuses. In this arrangement, the height of the filter appliance (18, 19) should preferably correspond as exactly as possible to the height of the filter cake (20). Whereas the filtration proceeds via simultaneous takeoff via both filter elements (18 and 19) and/or the outlets (14 and 16), the drying is carried out by adding the drying gas either via outlet (14) in the case of takeoff via outlet (16), that is to say from the inside to the outside, or, by exchanging the connections, in the reverse direction. For identical cake and filter heights, this gives the advantage of an even pressure drop distribution in the cake, and very uniform drying of the product. It can be advantageous to introduce additionally a small gas-introduction fraction of drying gas via the inlet (15), in order, in particular, in the case of excessively high degrees of filling, to be able to dry the topmost layers better, and to eliminate the dead space region forming otherwise over the filter cake (20). The arrangement of the exit bore holes of the fractal liquid distributor in the distributor plate (54) preferably proceeds at a ratio of hole spacing L (59) to the width B (58) of the annular channel of L/B=1 on the central circle line (57) of the annular channel.

The filtrate (40) which flows through the filter medium (11) can be removed via the preferably central outlet (14) at the base (12) of the lower filter housing.

The filter cake (20) can be washed in the FDS unit after the filtration.

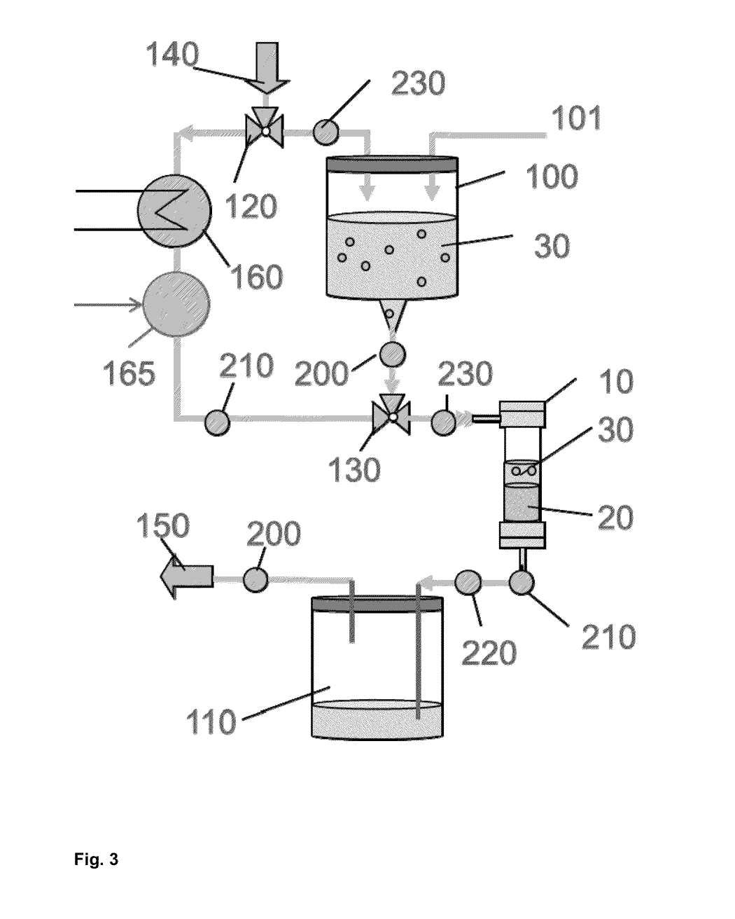

The inventive FDS unit is preferably used in a system as shown in FIG. 3, without restricting it. Before the protein crystals are dried, usually, the remaining filtrate (40) consisting of mother liquor or wash liquid is displaced from the filter cake (20) by means of a gas (140), preferably sterile-filtered air or nitrogen. The gas is usually introduced via the inlet (15), and the gas and/or liquid exit via the outlet (14). Preferably, at the latest, for drying the gas (140) the temperature is elevated to a defined level by a gas heater (160) and adjusted to a minimal residual moisture content via a gas humidifier (165). The latter is intended to prevent the product being irreversibly damaged, e.g., by aggregation, discolouration or caramelization, in the event of insufficient moisture content. In particular, the wrong residual moisture can lead to denaturation or difficulties in resolubilization (including losses of activity).

After drying has been carried out, inlet or outlet of the FDS unit can be clamped off. For example, flexible tube clamps (67) are suitable for this purpose with the flexible tubular lines (66) drawn onto the inlet (15) and outlet (14), preferably made of pharmaceutical-compliant silicone or C-Flex. Thus, the filtered, washed and dried protein crystals can be left in the FDS unit without intermediate opening, even during transport and subsequent storage. In this manner, a completely closed handling is permitted.

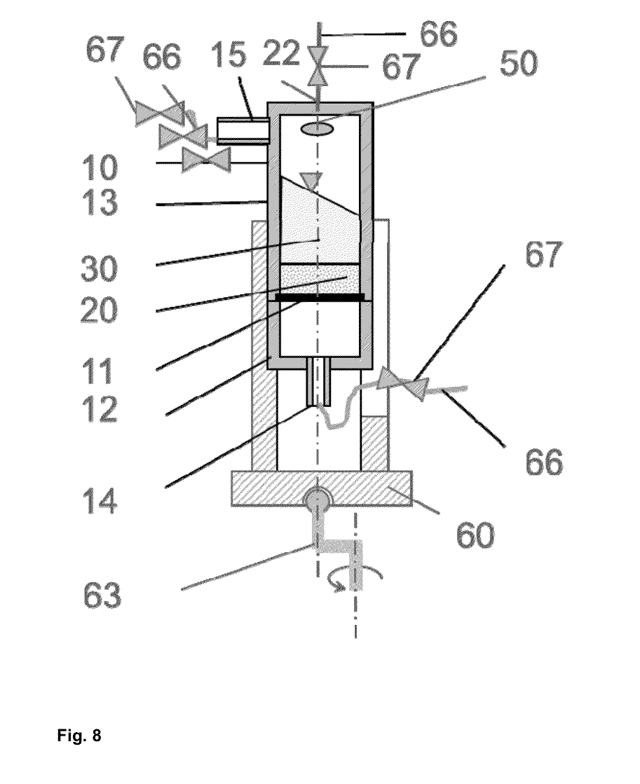

If the protein crystals are to be redissolved, product removal after opening the filter unit is advisable. However, preferably, resolubilization or resuspension is carried out within the FDS unit, with maintenance of the closed mode of operation. This can proceed non-invasively with moderate energy input, e.g. by backflushing (first via the outlet (14) and then via the inlet (15) using a suitable liquid. For improvement of the hydrodynamic mixing performance, the suspension of the crystals or ultimately increasing of the solubilization rate, the FDS unit can be agitated on a special orbital shaker (60) (FIG. 8). The shaker (60) has a vessel (62) for receiving the FDS unit including the flexible tubular lines (66) and the flexible tube clamps (67) and is put into an orbital oscillatory motion via a cam (63). In the case of integration of flow-breaking elements (e.g. polygonal cross section or flow disrupters) into the filter chamber (13) of the FDS unit, a vertical-rotary oscillating reactor motion can also ensure intensive mixing, suspension and accelerated solubilization.

The present invention therefore further relates to a system for operating the FDS unit according to the invention comprising
a crystallization tank (100) which is connected via lines to one or more reservoirs for crystallization and/or precipitation and correction media (101) and is connected on the other side to one or more FDS units according to the invention in parallel, sequential or intermittent operation,
a mother liquor reservoir (110) which is connected via connections to the outlet (14) of the FDS unit.

The technical crystallization of proteins (pharmaceutically active peptides and proteins and therapeutic antibodies) or other crystallizable or precipitatable active ingredients takes place in the crystallization tank (100) which has a sufficient number of connections to the reservoirs for all necessary crystallization and correction media.

After the crystallization, the suspension (30) is passed into the filter chamber (13) of the FDS unit as far as possible without particle damage, avoiding pumps, preferably by means of a slight overpressure, at moderate transport velocities. For this purpose, a gas pressure is connected to the top of the crystallization tank, e.g., via a three-way valve (120) and adjusted via a pressure meter (230). The crystal suspension is usually filtered at a filtration inlet pressure of 0.2 to 1.5 bar, preferably at 0.5 to 1.0 bar. The suspension (30) is retained by the filter medium (11, 17, 18 or 19 depending on the structure of the FDS unit). The filtrate (40) drained off from the outlet (14) of the FDS unit is, in a preferred embodiment, fed via a further three-way valve (130) to the filtrate reservoir (110).

The filtration is ended when all of the liquid from the crystallization tank (100) and FDS unit has been forced out, and so only the predried filter cake (20) remains in the FDS unit.

The filter cake (20), after the filtration, is still surrounded by the crystallization liquid. Preferably, the crystallization liquid is now replaced by a drying gas.

For this purpose, the drying gas can be passed through the filtration unit. Usually, for the drying, compressed gas of a defined residual moisture is used at an inlet pressure of 1 to 3 bar, preferably at 2 to 3 bar. Reconstruction of apparatus for drying is thus avoided.

In a preferred embodiment, the system for drying comprises a drying unit which comprises a separate drying gas line and three-way valves (120, 130). These are set in such a manner that the drying gas (at appropriate moisture loading) is conducted around the crystallization reactor via a bypass. For transport and heating of the drying gas, as gas heater (160), e.g. a tubular line having a heating jacket can be used. Furthermore, preferably the moisture content of the drying gas is set to a minimum value. For this purpose, the moisture of the drying gas is preferably adjusted before introduction into the drying unit and controlled by means of a moisture sensor (210). In the case of a relatively large moisture requirement, the minimum moisture can be adjusted via a moistening appliance (165) in the gas stream.

Preferably, the drying of the filter cake is likewise monitored by means of a moisture sensor (220) at the outlet of the single-use FDS unit. The filtrate (40) collected in the reservoir (110) during the filtration serves in the drying as wash liquid for the exhaust gas (150), in order to minimize dust emissions potentially occurring during drying.

In a further embodiment of the invention, the FDS unit according to the invention has a means for the minimally-invasive sampling of the filter cake. For example, the FDS unit has a sealable opening for introducing a sampling spade into the filter cake. Preferably, a sampling spade can be introduced horizontally and vertically into the filter cake.

The invention described hereinafter permits the combination of equally as many process steps of downstream processing of a solids suspension.

The present invention further relates therefore to a method for workup of a solids suspension, comprising the following steps:
1) filtration of a solids suspension in a single filter unit or filter unit connected in parallel according to any one of claims 1 to 6 in a system according to any one of claims 10 to 12;
2) washing or medium change of the retained solids and optionally convection drying of the retained solids by means of a drying gas;
3) withdrawing the solids-filled filtration unit from the system;
4) transporting and storing the solids-filled filtration unit and optionally reconstitution of the proteins by dissolution and/or resuspension in the filter unit.

Preferably, the convection drying is carried out with controllable parameters such as temperature, volumetric flow rate or moisture content or with a combination thereof.

By using filter plates having differing pore sizes, all of the steps described can be adapted to the respective application or the respective protein crystal suspension. Compared with stainless steel or glass designs, the single-use structure of the FDS unit according to the invention greatly reduces the expenditure on cleaning and on cleaning validation.

The single-use FDS unit according to the invention is suitable, in particular, for separating off protein crystals (pharmaceutically active peptides and proteins and therapeutic antibodies) without being restricted thereto. It is likewise advantageously usable for separating off other crystalline compounds, in particular when rules of good manufacturing practice for medicaments must be heeded.

The FDS unit according to the invention and also the system for application thereof are shown schematically, by way of example, in FIGS. 1 to 6, without being restricted to the embodiments shown.

FIG.1: FDS unit with filter plate

FIG. 2: FDS unit with filter candle

FIG. 3: Incorporation of the FDS unit into the system according to the invention for carrying out the filtration, drying and provision for transport and storage

FIG. 4: Fractal liquid distributor (side view: predistributor, distributor plate)

FIG. 5: Fractal distributor (plan view: distributor plate with example for division of the exit openings)

FIG. 6: FDS unit with filter candle, filter tube and fractal distributor for the annular space formed from two filter tubes, for the large scale

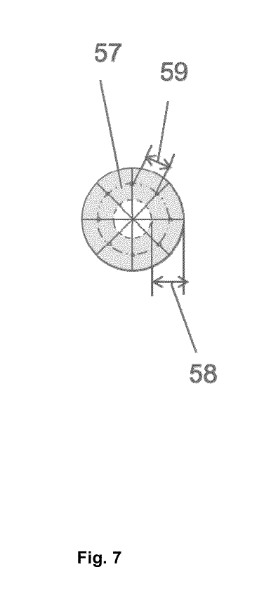

FIG. 7: Plan view onto FDS unit for the large process scale

FIG. 8: Orbital shaking appliance for non-invasive energy input into the FDS unit for the purposes of suspension and resolubilizing with closed process procedure.

### DRAWING LEGENDS

10 filter housing

11 filter medium

12 base

13 filter chamber

14 outlet

15 inlet

16 outlet

17 filter plate

18 filter candle

20 filter cake

22 venting tube

30 suspension

40 filtrate

50 liquid distributor

51 60° division

52 flexible tubular line

53 exit opening

54 distributor plate

56 predistributor

57 circle line

58 ring gap width

59 hole spacing

60 shaker

62 vessel

63 cam

66 flexible tubular line

67 flexible tube clamp

100 crystallization tank/precipitation tank

101 correction medium

110 reservoir

120 three-way tap/valve

130 three-way tap/valve

140 gas

150 offgas

160 gas heater

165 gas humidifier

200 flow metering

210 moisture/temperature sensor

220 moisture sensor

230 pressure measurement

### EXAMPLE:

For the filtration of a model protein, an FDS unit according to FIG. 1 was made from a filter housing (10) having a volume of the filter chamber (13) of 100 ml, a diameter of 26 mm and a degree of slenderness of 5.8 and a screw-mountable base part (12) made of polyoxymethylene (POM). The wall thicknesses of the filter housing (10) and base (12) were dimensioned for the selected conditions of an operating pressure up to 3 bar and a temperature from −10≦[T° C.]60° . As filter medium (11), sintered metal plates having a pore size of 5 μm were used (diameter 34 mm; thickness 5 mm). Filter chamber (13), filter medium (11) and base (12) were fastened together by means of clamped connections using a closure clamp (Triclamp).

Crystallization

The model protein was introduced dissolved in a concentration of 10 g/l in 40 mM Na-citrate (initial pH 2.7). This was followed by the addition of the precipitant (sodium hydroxide solution 0.75 M; addition of 15 ml in 5 minutes) up to a nucleation pH of 3.2. At this pH, the solution was stirred for a further 3 hours (agitator speed 200 rpm). After the nucleation time, the precipitant was added to the solution to a final pH of 4.5. The solution was agitated at room temperature for a further 17 hours.

Optimum process parameters of the subsequent filtration and drying of the protein crystals were determined by statistical design of experiments. A response surface model was prepared from which the principal and two-factor reactions and also the optimum process parameters result.

Filtration

For the model protein used, an optimum filtration inlet pressure of 0.5 bar was determined. For the model protein used, an optimum cake height of 4.5 cm (±0.5) was determined.

Drying

For the model protein used, an optimum inlet pressure of compressed air of 2.5 bar (±0.5) was determined. The drying temperature (temperature of the compressed gas) is dependant on the temperature stability of the target protein and was set between 30° C. and 50° C. For the model protein used, compressed air having an optimum temperature of 45° C. (±5) was used. The relative moisture of the compressed air of 0.5-1.0% was able to be provided without an additional air humidifier. It was dimensioned sufficiently to prevent product damage by excessive drying out of the filter cake. For the model protein used, an optimum drying time of 17.5 h (±1) was determined. Using the gas heater (160) constructed from a tube line having a heating jacket, volumetric flow rates of up to 4 m³/h could be heated to a temperature of 55° C.

Under the abovementioned experimental conditions, the following measured values were determined:

| | |
|---|---|
| Crystallization yield: | 98 [%] |
| Product loss in the mother liquor: | 1 [%] |
| Filtration flux: | 1556 [l/h × m² × bar] |
| Solids/FDS unit (load capacity): | 13 [g of crystal solid/FDS unit] |
| | (vol: 22 cm³) |
| Residual moisture content (Karl- | 4 [%] |
| Fisher method): | |
| Product purity (RP-HPLC): | 95 [%] |

1. Filter unit for filtration of solid particles from a suspension comprising:
a filter housing comprising a filter chamber, a liquid distributor at the end of at least one inlet to the filter chamber and a base and
a filter medium, wherein the filter chamber and the base are connected in the region of the filter medium by a connection so as to seal against the surroundings and against the filter medium,
at least one outlet on the base of the filter housing.

2. Filter unit according to claim 1, wherein the filter housing is made of plastic.

3. Filter unit according to claim 1, wherein the filter housing is constructed entirely or in part as a plastics pouch.

4. Filter unit according to claim 1, wherein the filter medium is selected from a group consisting of one or more filter plate, cylindrical filter, candle or combination thereof.

5. Filter unit according to claim 1, wherein the filter chamber and the base are non-detachably connected.

6. Filter unit according to claim 1, wherein a liquid distributor with filter plate is used for liquid distribution.

7. Liquid distributor comprising a predistributor connected to a distributor plate by means of flexible tubular lines of equal length and equal diameter, wherein the flexible tubular lines, with expansion and a gradient as continuous as possible, open out into vertical exit openings of the distributor plate, characterized in that the exit openings are arranged on concentric tracks.

8. Liquid distributor according to claim 7, wherein the exit openings are arranged at a 60° arrangement and the same distances from one another, with a constant distance to the outer wall of the filter chamber, or are arranged with a best possible combination thereof.

9. Liquid distributor according to claim 7, wherein each exit opening is connected to the predistributor with the aid of an unbranched flexible tubular line.

10. System for filtration of solid particles from a suspension, comprising:
a crystallization tank which is connected temporarily via lines to one or more reservoirs for crystallization and correction media at one end and is temporarily connected at the other to a filter unit according to any one of claims 1 to 6, or to a plurality thereof in parallel and a mother liquor reservoir which is temporarily connected via connections to the outlet of the filter unit.

11. System according to claim 10, comprising a drying unit, a moistening unit, or both.

12. System according to claim 11, comprising a means for non-invasive agitation of the contents of the FDS unit selected from the group consisting of an orbital shaker or a vertical rotary-oscillating shaker.

13. Method for downstream processing of a solids suspension, comprising the following steps:
filtration of the solids suspension in a filter unit according to claim 1;
washing or medium change of the retained solids and optionally convection drying of the retained crystals by means of a drying gas;
withdrawing the solids-filled filtration unit from the system;
transporting and storing the solids-filled filtration unit and optionally reconstitution of the proteins by dissolution in the filter unit.

14. Method according to claim 13, wherein the convection drying is carried out with a controllable temperature, volumetric flow rate or moisture content or with a combination thereof.
